(19) United States
(12) Patent Application Publication
(10) Pub. No.: US 2010/0199802 A1
(43) Pub. Date: Aug. 12, 2010

(54) Steering Wheel Enhancement Apparatus

(76) Inventors: Carlo F. Guillaume, Coral Springs, FL (US); Sharon Mohan, Coral Springs, FL (US)

Correspondence Address: HARSHAW RESEARCH, INC., 210 W. TECUMSEH STREET, OTTAWA, KS, 66067, US

(21) Appl. No.: 12/367,917

(22) Filed: Feb. 9, 2009

(51) Int. Cl. B62D 1/11

(52) U.S. Cl. 74/558

(57) ABSTRACT

An enhancement apparatus for a steering wheel includes a front arcuate shell having first and second opposed ends and an interior area. The apparatus includes a rear arcuate shell having first and second opposed ends and an interior area, the rear arcuate shell having a configuration complementary to a configuration of the front arcuate shell for attachment thereto. The apparatus includes compressible foam in the front arcuate shell and compressible foam in the rear arcuate shell configured to jointly sandwich an exposed structural core of the steering wheel. At least one fastener couples the front arcuate shell to the rear arcuate shell while the compressible foam in the front and rear arcuate shells sandwich the exposed structural core of the steering wheel.

### BACKGROUND OF THE INVENTION

This invention relates generally to vehicle steering wheel devices and, more particularly to a steering wheel enhancement apparatus that may be installed on a standard steering wheel and that customizes the aesthetic appearance of the steering wheel.

Customizing an automobile to match one's personal preference or personality has become increasingly popular. Enhancing certain aspects of a vehicle may also increase the value or perceived value of the vehicle. For example, the addition of white walled tires, chrome wheels, or a custom paint job may significantly change the character of an automobile's appearance.

One of the signature touches of high-end cars is a wooden accent on the steering wheel. Owners of these automobiles appreciate the sophisticated aesthetic appearance of such a steering wheel and also its characteristic to stay cool on hot days. Persons driving cars that did not come standard with an accented steering wheel must resort to purchasing a new steering wheel in order to obtain the above mentioned benefits.

Various devices have been proposed in the art for customizing a steering wheel. In addition to complete steering wheel replacement, a complete cover or sleeve may be installed. Although assumably effective for their intended purposes, the existing devices do not provide for modification of an existing steering wheel to include wooden accents (or other custom materials) while still retaining the original functionality of the steering wheel, such as airbags.

Therefore, it would be desirable to have a steering wheel enhancement device that enables a traditional steering wheel to be modified to include custom material accents. Further, it would be desirable to have a steering wheel enhancement device that enables a modified steering wheel to maintain its functionality. In addition, it would be desirable to have a steering wheel enhancement device that includes a template for allowing accents to be easily installed on steering wheels of different sizes and models.

### SUMMARY OF THE INVENTION

Therefore, an enhancement apparatus for a steering wheel includes a front arcuate shell having first and second opposed ends and an interior area. The apparatus includes a rear arcuate shell having first and second opposed ends and an interior area, the rear arcuate shell having a configuration complementary to a configuration of the front arcuate shell for attachment thereto. The apparatus includes compressible foam in the front arcuate shell and compressible foam in the rear arcuate shell configured to jointly sandwich an exposed structural core of the steering wheel. At least one fastener couples the front arcuate shell to the rear arcuate shell while the compressible foam in the front and rear arcuate shells sandwich the exposed structural core of the steering wheel.

Therefore, a general object of this invention is to provide a steering wheel enhancement device for customizing a traditional steering wheel.

Another object of this invention is to provide a steering wheel enhancement device, as aforesaid, that provides for removing a portion of a traditional steering wheel and mounting of custom material members.

Still another object of this invention is to provide a steering wheel enhancement device, as aforesaid, that does not eliminate or affect the original functionality of an original steering wheel, such as air bags, cruise control buttons, etc.

Yet another object of this invention is to provide a steering wheel enhancement device, as aforesaid, that includes a template to guide installation on steering wheels of various sizes or vehicle types.

A further object of this invention is to provide a steering wheel enhancement device, as aforesaid, with which various accent materials may be installed, such as wood, leather, or composite materials.

A still further object of this invention is to provide a steering wheel enhancement device, as aforesaid, in which the trim pieces surround the steering wheel.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a traditional steering wheel;

FIG. 1b is a perspective view of the steering wheel as in FIG. 1a with opposed portions of the steering wheel removed;

FIG. 2a is an exploded view of a steering wheel enhancement device according to a preferred embodiment of the present invention positioned for attachment to the steering wheel as in FIG. 1b;

FIG. 2b is an isolated view on an enlarged scale taken from FIG. 2a;

FIG. 3 is a perspective view of the steering wheel enhancement device as in FIG. 2a installed upon the steering wheel;

FIG. 4a is a perspective view of a transition device in a closed configuration;

FIG. 4b is a perspective view of a transition device in an open configuration;

FIG. 5a is a top view of the transition device as in FIG. 4a;

FIG. 5b is a sectional view taken along line 5b-5b of FIG. 5a;

FIG. 5c is an isolated view on an enlarged scale taken from FIG. 5b;

FIG. 6a is a perspective view of the rear shell of the steering wheel enhancement device;

FIG. 6b is an isolated view on an enlarged scale taken from FIG. 6a; and

FIG. 7 is a template for use in installing the steering wheel enhancement device.

### DESCRIPTION OF THE PREFERRED EMBODIMENT

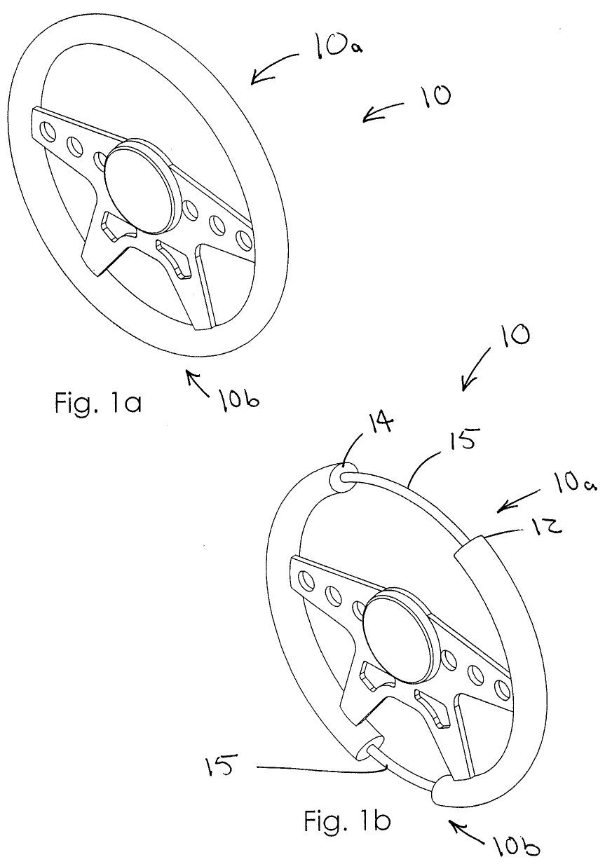

A steering wheel enhancement apparatus will now be described in detail with reference to FIG. 1a through FIG. 7 of the accompanying drawings. More particularly, an enhancement apparatus 100 for a steering wheel 10 includes a front arcuate shell 110 and a rear arcuate shell 120.

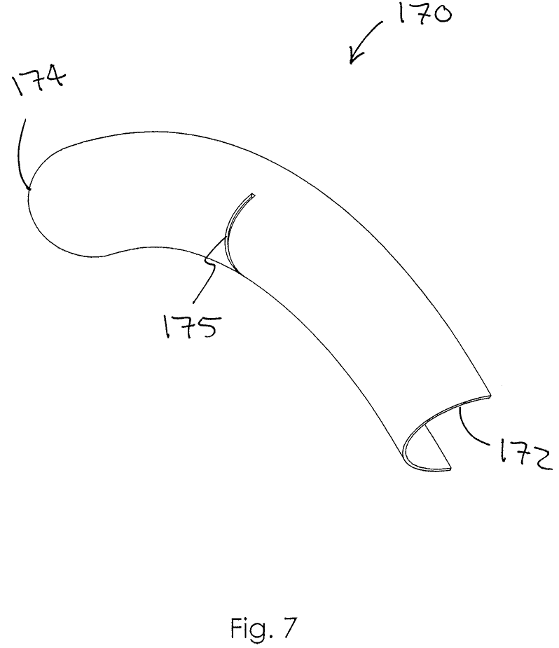

As shown in FIG. 7, a template 170 for preparing the steering wheel 10 may be included, or the steering wheel 10 may otherwise be configured as set forth herein and shown in FIG. 1b. The template 170 may be configured to border the steering wheel 10 (e.g., the template 170 may be molded of plastic to be both arcuate and curved). The template has one guide (e.g., edge 172) for cutting the steering wheel 10 to create a first cut edge 12 (FIG. 1b) and another guide (e.g., edge 174) for cutting the steering wheel 10 to create a second cut edge 14 (FIG. 1b). A center indicator 175 may also be included.

To use the template 170, the template 170 may be placed on the steering wheel 10 (e.g., the center indicator 175 may be located at the center of the top 10a or bottom 10b side of the steering wheel 10), a knife or other cutting tool may follow edge 172 to cut the steering wheel 10 and create the first cut edge 12 (FIG. 1b), and the knife or other cutting tool may follow edge 174 to cut the steering wheel 10 and create the second cut edge 14 (FIG. 1b). As shown in FIG. 1b, a portion of the steering wheel 10 between the first and second cut edges 12, 14 is then removable to expose a structural core 15 of the steering wheel 10.

A single template 170 may have various guides to allow both top and bottom sides 10a, 10b of the steering wheel 10 to be removed, as shown in FIGS. 1a and 1b, or multiple templates 170 of different sizes may be included to allow both top and bottom sides 10a, 10b of the steering wheel 10 to be removed, or only one side 10a, 10b may be removed. While reference is generally made herein to the top side 10a and elements for enhancing the top side 10a, it should be understood by one of ordinary skill in the art that these teachings may similarly be used for the bottom side 10b, as shown in various accompanying drawings.

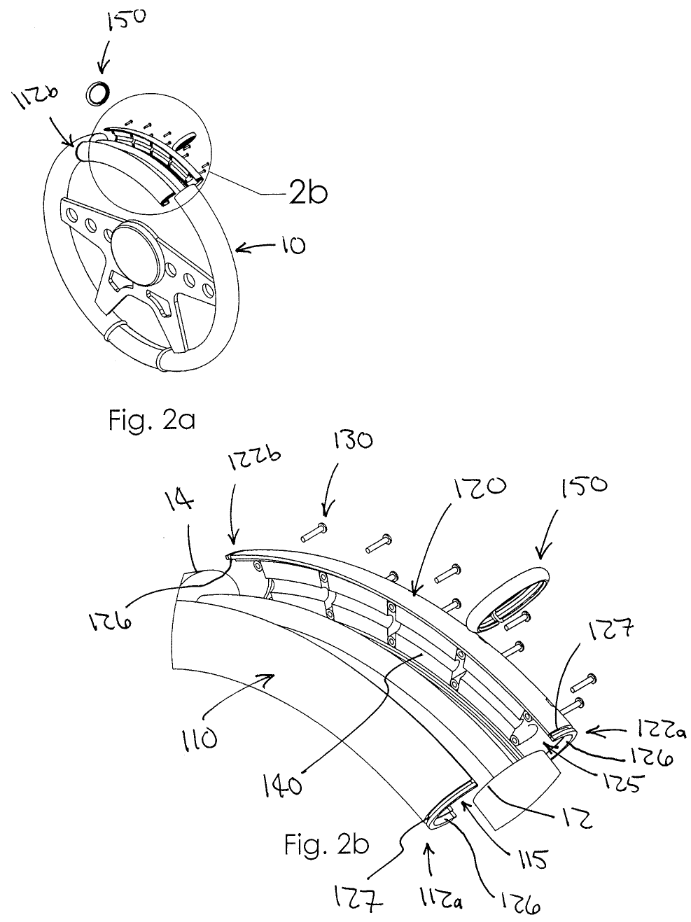

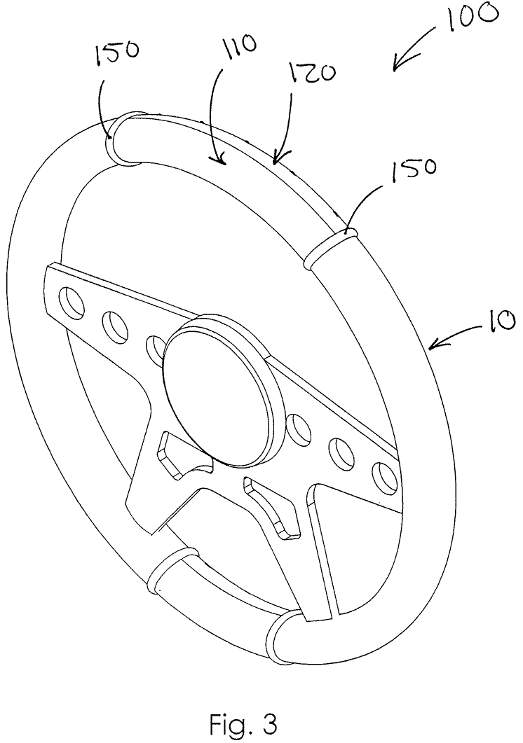

Turning to FIG. 2a through FIG. 3, the front arcuate shell 110 has first and second opposed ends 112a, 112b and an interior area 115. The front shell 110 is sized such that the first end 112a is adjacent the first cut edge 12 and the second end 112b is adjacent the second cut edge 14. Further, the front shell 110 may have a flexible diameter to allow the front shell interior area 115 to be increased and/or reduced. Similar to the front shell 110, the rear arcuate shell 120 has first and second opposed ends 122a, 122b and an interior area 125. The rear shell 120 is sized such that the first end 122a is adjacent the first cut edge 12 and the second end 122b is adjacent the second cut edge 14. The rear shell 120 has a configuration complementary to a configuration of the front shell 110 so that the front and rear shells 110, 120 may be coupled together, and the rear shell 120 may have a flexible diameter to allow the rear shell interior area 125 to be increased and/or reduced.

While the accompanying drawings generally show the interior areas 115, 125 to be generally equal, the interior area 115 is larger than the interior area 125 in some embodiments (e.g., in a two-to-one ratio) to alter placement of the seam between the front and rear arcuate shells 110, 120. In addition, the rear shell 120 may include grip features (e.g., channels) configured to receive a user's fingers. Various materials may be used to construct the front and rear shells 110, 120, such as wood, metal, plastic, and leather. If plastic is used, it may be finished to resemble other materials, such as wood.

As shown in FIG. 2b, the first and second ends 112a, 112b of the front shell 110 and the first and second ends 122a, 122b of the rear shell 120 may be recessed (denoted 126) to overlay the first and second cut edges 12, 14. In other embodiments, some or all of the first and second ends 112a, 112b, 122a, 122b of the shells 110, 120 may instead be adjacent the cut edges 12, 14 without overlaying.

At least one fastener 130 (FIG. 2b) is included to couple the front shell 110 to the rear shell 120 while the front and rear shells 110, 120 surround the exposed structural core 15 of the steering wheel 10. The fastener 130 may be a screw, nail, locking tab, adhesive, or any other appropriate fastening device.

Means for filling a portion of the front shell interior area 115 and/or means for filling a portion of the rear shell interior area 125 may be included such that the exposed structural core 15 of the steering wheel 10 is gripped when the front and rear shells 110, 120 surround the exposed structural core 15 of the steering wheel 10 (e.g., when the front and rear shells 110, 120 are coupled together, as shown in FIG. 3). This may include, for example, foam 140 (FIG. 2b), rubber, or any other appropriate filler material. It may be desirable for the filler material to be compressible to account for structural cores 15 of various sizes, and the filler material may jointly sandwich the structural core 15 of the steering wheel 10 when the front and rear shells 110, 120 are placed to surround the exposed structural core 15. The filler material may be removable and replaceable with a different type or amount of filler material. This may be desirable, for example, if the interior areas 115, 125 are reduced or increased and to account for large variations in sizes of different exposed structural cores 15.

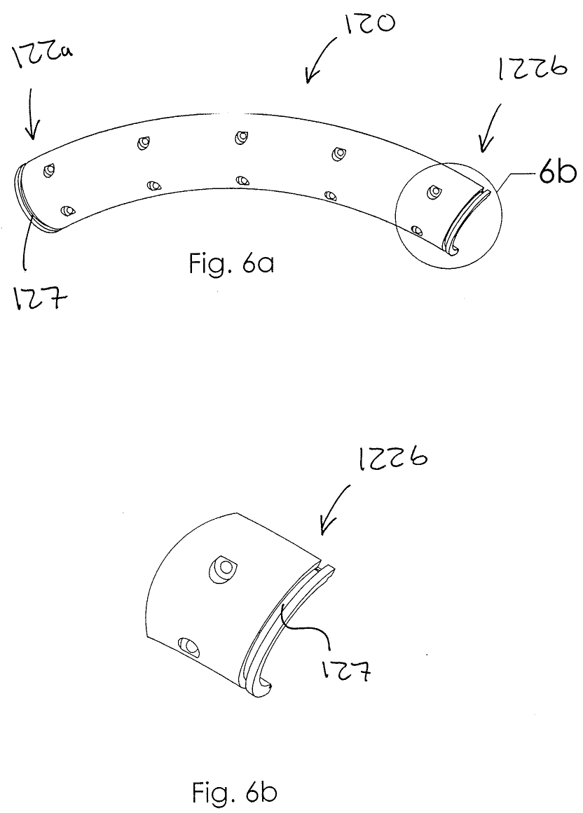

As shown in FIG. 2b, FIG. 6a, and FIG. 6b, the first and second ends 112a, 112b of the front shell 110 and/or the first and second ends 122a, 122b of the rear shell 120 may define grooves 127. If the front shell first end 112a and the rear shell first end 122a both define grooves 127, those grooves may collectively define a continuous (or otherwise aligned) groove when the front and rear shells 110, 120 are coupled together. Similarly, if the front shell second end 112b and the rear shell second end 122b both define grooves 127, those grooves may collectively define a continuous (or otherwise aligned) groove when the front and rear shells 110, 120 are coupled together.

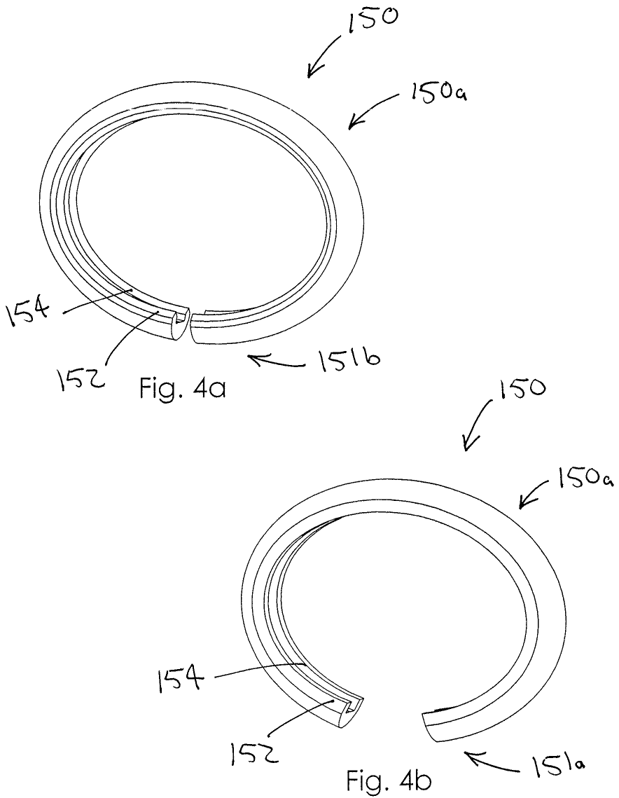

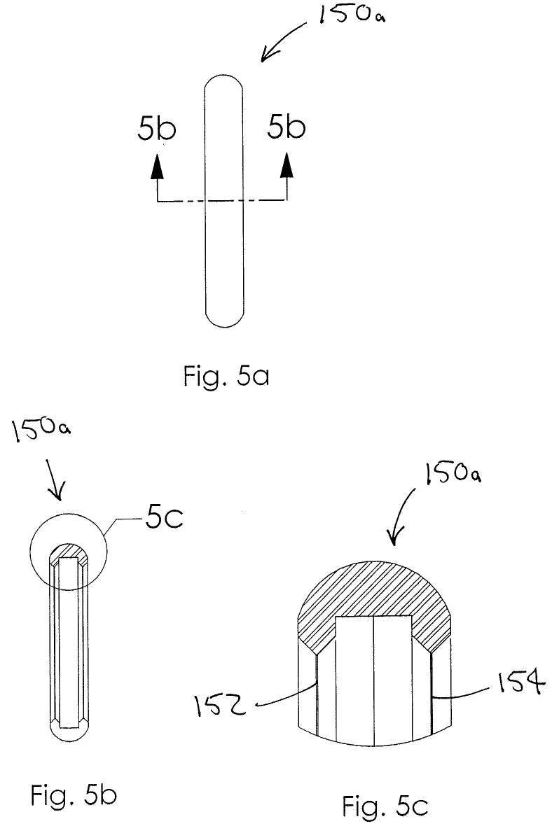

A transition device 150 may be included that has means for interacting with the front shell first end 112a and/or the rear shell first end 122a and means for gripping the steering wheel 10 to transition between the front and rear shells 110, 120 and the steering wheel 10. Another transition devices 150 (or a different transition device) may similarly be used to interact with the front shell second end 112b and/or the rear shell second end 122b and to grip the steering wheel 10 to transition between the front and rear shells 110, 120 and the steering wheel 10. As shown in FIG. 4a through FIG. 5c, a deformable ring 150a transition device 150 may have a first protrusion 152 complementary to the grooves 127 and a second protrusion 154 for gripping the steering wheel 10. The ring 150a is deformable from an open configuration 151a (FIG. 4b) in which the ring 150a is separate from the groove(s) 127 and separate from the steering wheel 10 to a closed configuration 151b (FIG. 4a) in which the first protrusion 152 is inside at least one groove 127 and the second protrusion grips the steering wheel 10.

In use, the template 170 may be utilized as set forth above to prepare the steering wheel 10. The front and rear shells 110, 120 are positioned to surround the exposed structural core 15 of the steering wheel 10, and the fastener(s) 130 couple the front and rear shells 110, 120 together. The flexible diameters of the front and rear shells 110, 120 may allow standard (or “universal”) front and rear shells 110, 120 to be used with various steering wheels 10. The filler material (e.g., foam 140) may provide a desirable compression (or “feel”) for the enhanced steering wheel. As set forth above, recesses 126 may allow the front and rear shells 110, 120 to overlay one or both of the first and second cut edges 12, 14. If the grooves 127 and transition device(s) 150 are included, a protrusion 152 may be positioned to enter the groove(s) 127 adjacent the first cut end 12 (i.e., enter groove 127 in front shell first end 112a and/or enter groove 127 in rear shell first end 122a). The transition device 150a may then be deformed to the closed configuration 151b (FIG. 4a), causing the protrusion 154 to grip the steering wheel 10. Similarly, another protrusion 152 may be positioned to enter the groove(s) 127 adjacent the second cut end 14 (i.e., enter groove 127 in front shell second end 112b and/or enter groove 127 in rear shell second end 122b). This transition second device 150a may then be deformed to the closed configuration 151b (FIG. 4a), causing the protrusion 154 to grip the steering wheel 10. As a result, the steering wheel 10 may be customized to provide a desired look and/or feel.

It is understood that while certain forms of this invention have been illustrated and described, it is not limited thereto except insofar as such limitations are included in the following claims and allowable functional equivalents thereof.

1. An enhancement apparatus for a steering wheel, said enhancement apparatus comprising:
a front arcuate shell having first and second opposed ends and an interior area;
a rear arcuate shell having first and second opposed ends and an interior area, said rear arcuate shell having a configuration complementary to a configuration of said front arcuate shell for attachment thereto;
compressible foam in said front arcuate shell and compressible foam in said rear arcuate shell configured to jointly sandwich an exposed structural core of said steering wheel; and
at least one fastener to couple said front arcuate shell to said rear arcuate shell while said compressible foam in said front and rear arcuate shells sandwich said exposed structural core of said steering wheel.

2. The enhancement apparatus of claim 1, wherein:
said first ends of said front and rear arcuate shells are recessed to overlay a first cut edge of said steering wheel; and
said second ends of said front and rear arcuate shells are recessed to overlay a second cut edge of said steering wheel.

3. The enhancement apparatus of claim 2:
wherein said first ends of said front and rear arcuate shells collectively define a first groove when said front and rear arcuate shells are coupled together;
wherein said second ends of said front and rear arcuate shells collectively define a second groove when said front and rear arcuate shells are coupled together;
further comprising a first ring having a first protrusion complementary to said first groove and a second protrusion for gripping said steering wheel, said first ring being deformable from an open configuration in which said first ring is separate from said first groove and said steering wheel and a closed configuration in which said first protrusion of said first ring is inside said first groove and said second protrusion of said first ring grips said steering wheel; and
further comprising a second ring having a first protrusion complementary to said second groove and a second protrusion for gripping said steering wheel, said second ring being deformable from an open configuration in which said second ring is separate from said second groove and said steering wheel and a closed configuration in which said first protrusion of said second ring is inside said second groove and said second protrusion of said second ring grips said steering wheel.

4. The enhancement apparatus of claim 3, wherein:
said front arcuate shell has a flexible diameter to allow said front arcuate shell interior area to be respectfully increased and reduced; and
said rear arcuate shell has a flexible diameter to allow said rear arcuate shell interior area to be respectfully increased and reduced.

5. The enhancement apparatus of claim 4, wherein:
said compressible foam in said front arcuate shell is removable and replaceable with compressible foam sized to correspond to an increased front arcuate shell interior area; and
said compressible foam in said rear arcuate shell is removable and replaceable with compressible foam sized to correspond to an increased rear arcuate shell interior area.

6. The enhancement apparatus of claim 5, further comprising a template having a center indicator, a guide for cutting said steering wheel to create said first cut edge, and a guide for cutting said steering wheel to create said second cut edge.

7. The enhancement apparatus of claim 1:
wherein said first ends of said front and rear arcuate shells collectively define a first groove when said front and rear arcuate shells are coupled together;
wherein said second ends of said front and rear arcuate shells collectively define a second groove when said front and rear arcuate shells are coupled together;
further comprising a first ring having a first protrusion complementary to said first groove and a second protrusion for gripping said steering wheel, said first ring being deformable from an open configuration in which said first ring is separate from said first groove and said steering wheel and a closed configuration in which said first protrusion of said first ring is inside said first groove and said second protrusion of said first ring grips said steering wheel; and
further comprising a second ring having a first protrusion complementary to said second groove and a second protrusion for gripping said steering wheel, said second ring being deformable from an open configuration in which said second ring is separate from said second groove and said steering wheel and a closed configuration in which said first protrusion of said second ring is inside said second groove and said second protrusion of said second ring grips said steering wheel.

8. The enhancement apparatus of claim 1, further comprising:
a first transition device having means for interacting with at least one of said front arcuate shell first end and said rear arcuate shell first end and means for gripping said steering wheel to transition between said front and rear arcuate shells and said steering wheel; and
a second transition device having means for interacting with at least one of said front arcuate shell second end and said rear arcuate shell second end and means for gripping said steering wheel to transition between said front and rear arcuate shells and said steering wheel.

9. The enhancement device of claim 1, wherein:
said front arcuate shell has a flexible diameter to allow said front arcuate shell interior area to be respectfully increased and reduced; and
said rear arcuate shell has a flexible diameter to allow said rear arcuate shell interior area to be respectfully increased and reduced.

10. The enhancement apparatus of claim 9, wherein:
said compressible foam in said front arcuate shell is removable and replaceable with compressible foam sized to correspond to an increased front arcuate shell interior area; and
said compressible foam in said rear arcuate shell is removable and replaceable with compressible foam sized to correspond to an increased rear arcuate shell interior area.

11. An enhancement apparatus for a steering wheel, said enhancement apparatus comprising:
a template having a center indicator, a guide for cutting said steering wheel to create a first cut edge, and a guide for cutting said steering wheel to create a second cut edge; a portion of said steering wheel between said first and second cut edges being removable to expose a structural core;
a front arcuate shell having first and second opposed ends and an interior area;
a rear arcuate shell having first and second opposed ends and an interior area, said rear arcuate shell having a configuration complementary to a configuration of said front arcuate shell for attachment thereto; and
at least one fastener to couple said front arcuate shell to said rear arcuate shell while said front and rear arcuate shells surround said exposed structural core of said steering wheel.

12. The enhancement apparatus of claim 11, further comprising means for filling a portion of said front arcuate shell interior area and means for filling a portion of said rear arcuate shell interior area, whereby said exposed structural core of said steering wheel is gripped when said front and rear arcuate shells surround said exposed structural core of said steering wheel.

13. The enhancement apparatus of claim 11, wherein:
at least one of said front arcuate shell first end and said rear arcuate shell first end is recessed to overlay said first cut edge of said steering wheel; and
at least one of said front arcuate shell second end and said rear arcuate shell second end is recessed to overlay said second cut edge of said steering wheel.

14. The enhancement apparatus of claim 11:
wherein at least one of said front arcuate shell first end and said rear arcuate shell first end defines a first groove;
wherein at least one of said front arcuate shell second end and said rear arcuate shell second end defines a second groove;
further comprising a first ring having a first protrusion complementary to said first groove and a second protrusion for gripping said steering wheel, said first ring being deformable from an open configuration in which said first ring is separate from said first groove and said steering wheel and a closed configuration in which said first protrusion of said first ring is inside said first groove and said second protrusion of said first ring grips said steering wheel; and
further comprising a second ring having a first protrusion complementary to said second groove and a second protrusion for gripping said steering wheel, said second ring being deformable from an open configuration in which said second ring is separate from said second groove and said steering wheel and a closed configuration in which said first protrusion of said second ring is inside said second groove and said second protrusion of said second ring grips said steering wheel.

15. The enhancement apparatus of claim 11, wherein:
said front arcuate shell has a flexible diameter to allow said front arcuate shell interior area to be respectfully increased and reduced; and
said rear arcuate shell has a flexible diameter to allow said rear arcuate shell interior area to be respectfully increased and reduced.

16. The enhancement apparatus of claim 15, wherein at least one of said front arcuate shell first end and said rear arcuate shell first end defines a first groove, wherein at least one of said front arcuate shell second end and said rear arcuate shell second end defines a second groove, further comprising:
means for filling a portion of said front arcuate shell interior area and means for filling a portion of said rear arcuate shell interior area, whereby said exposed structural core of said steering wheel is gripped when said front and rear arcuate shells surround said exposed structural core of said steering wheel;
a first ring having a first protrusion complementary to said first groove and a second protrusion for gripping said steering wheel, said first ring being deformable from an open configuration in which said first ring is separate from said first groove and said steering wheel and a closed configuration in which said first protrusion of said first ring is inside said first groove and said second protrusion of said first ring grips said steering wheel; and
a second ring having a first protrusion complementary to said second groove and a second protrusion for gripping said steering wheel, said second ring being deformable from an open configuration in which said second ring is separate from said second groove and said steering wheel and a closed configuration in which said first protrusion of said second ring is inside said second groove and said second protrusion of said second ring grips said steering wheel.

17. An enhancement apparatus for a steering wheel, said enhancement apparatus comprising:
a template having a guide for cutting said steering wheel to create a first cut edge and a guide for cutting said steering wheel to create a second cut edge; a portion of said steering wheel between said first and second cut edges being removable to expose a structural core;
a front arcuate shell having first and second opposed ends and an interior area, said front arcuate shell first end being adjacent said first cut edge, said front arcuate shell second end being adjacent said second cut edge;
a rear arcuate shell having first and second opposed ends and an interior area, said rear arcuate shell first end being adjacent said first cut edge, said rear arcuate shell second end being adjacent said second cut edge; and
at least one fastener to couple said front arcuate shell to said rear arcuate shell while said front and rear arcuate shells surround said exposed structural core of said steering wheel.

18. The enhancement apparatus of claim 17, wherein:
at least one of said front arcuate shell first end and said rear arcuate shell first end is recessed to overlay said first cut edge of said steering wheel; and
at least one of said front arcuate shell second end and said rear arcuate shell second end is recessed to overlay said second cut edge of said steering wheel.

19. The enhancement apparatus of claim 17:
wherein at least one of said front arcuate shell first end and said rear arcuate shell first end defines a first groove;
wherein at least one of said front arcuate shell second end and said rear arcuate shell second end defines a second groove;
further comprising a first ring having a first protrusion complementary to said first groove and a second protrusion for gripping said steering wheel, said first ring being deformable from an open configuration in which said first ring is separate from said first groove and said steering wheel and a closed configuration in which said first protrusion of said first ring is inside said first groove and said second protrusion of said first ring grips said steering wheel; and
further comprising a second ring having a first protrusion complementary to said second groove and a second protrusion for gripping said steering wheel, said second ring being deformable from an open configuration in which said second ring is separate from said second groove and said steering wheel and a closed configuration in which said first protrusion of said second ring is inside said second groove and said second protrusion of said second ring grips said steering wheel.

20. The enhancement apparatus of claim 17, wherein said front arcuate shell has a flexible diameter to allow said front arcuate shell interior area to be respectfully increased and reduced, said enhancement apparatus further comprising means for filling a portion of said front arcuate shell interior area and means for filling a portion of said rear arcuate shell interior area, whereby said exposed structural core of said steering wheel is gripped when said front and rear arcuate shells surround said exposed structural core of said steering wheel.
